(19) United States
(12) Patent Application Publication
(10) Pub. No.: US 2009/0162587 A1
(43) Pub. Date: Jun. 25, 2009

(54) ASSEMBLY AND METHOD TO IMPROVE VACUUM RETENTION IN EVACUATED SPECIMEN CONTAINERS

(75) Inventors: Bradley Wilkinson, North Haledon, NJ (US); Robert Golabek, Towaco, NJ (US)

Correspondence Address: David W. Highet, VP & Chief IP Counsel;Becton, Dickinson and Company, 1 Becton Drive, MC 110, Franklin Lakes, NJ, 07417-1880, US

(73) Assignee: BECTON, DICKINSON AND COMPANY, Franklin Lakes, NJ (US)

(21) Appl. No.: 11/961,669

(22) Filed: Dec. 20, 2007

(51) Int. Cl. B01L 3/00; B32B 1/02; B32B 29/00; B32B 27/00; B32B 38/00

(52) U.S. Cl. 428/34.2; 428/34.1; 422/102; 422/101; 428/36.6; 156/286

(57) ABSTRACT

An assembly and method is provided for improved vacuum retention in evacuated biological sample collection primary containers. Such primary containers include but are not limited to blood collection tubes, evacuated blood collection tubes, centrifuge tubes, culture bottles, and syringe barrels. In one embodiment an evacuated blood collection tube is enclosed within an evacuated secondary container which is made from a gas barrier material.

### BACKGROUND OF THE INVENTION

Various techniques have been devised in an attempt to reduce gas and water vapor permeability of containers fabricated from PP, PET and other resins. Such techniques include addition of inorganic fillers, coating the containers with resins having barrier properties, plasma chemical vapor deposition coating of inorganic materials, and blending, laminating or co-extruding the resins with barrier resins.

While such efforts have offered some improvement, the need to consistently meet high performance standards suggests further improvements are needed.

### SUMMARY OF THE INVENTION

The various embodiments of the invention provide an assembly and method for improved vacuum retention in evacuated biological sample collection primary containers. Such primary containers include but are not limited to blood collection tubes, centrifuge tubes, and culture bottles.

In one embodiment, an assembly is provided having a single primary evacuated container encapsulated in a secondary evacuated container such as an outer package. Alternate terms which have the same definition as encapsulated include enclosed, contained, enveloped, sheathed and wrapped. The primary evacuated container is a biological sample collection container such as an evacuated blood collection tube. The secondary container is an outer package made from a gas barrier material such as a polymeric film/metallic foil laminate. The gas barrier material and seals of the secondary container inhibit the ingress of a gas into the internal environment of the evacuated secondary container thereby improving the vacuum retention within the primary evacuated container. The term evacuated container is defined as an enclosed space within the container from which matter, especially air, has been partially removed so that the matter or gas remaining in the space exerts less pressure than the atmosphere. Thus the internal environment of the sealed secondary evacuated container is below atmospheric pressure. Advantageously, the internal environment of the sealed secondary evacuated container is equal to or less than the pressure within the primary evacuated container.

In another embodiment, a roll of assemblies is provided, each assembly having a single primary evacuated container enclosed in a secondary evacuated container which are connected to form a continuous roll of individual assemblies. The secondary container is made from a gas barrier material such as a polymeric film/metallic foil laminate.

In a further embodiment, an assembly is provided having multiple primary evacuated containers enclosed in single secondary evacuated container. The multiple primary evacuated containers are evacuated blood collection tubes. The secondary container is made from a gas barrier material such as a polymeric film/metallic foil laminate.

An additional embodiment provides a method of assembly in which a primary evacuated container is inserted into a secondary container; and the secondary container is evacuated and then sealed. The secondary container is made from a gas barrier material.

### DESCRIPTION OF THE DRAWINGS

FIG. 1 is a perspective view of an evacuated blood collection tube;

FIGS. 2 and 3 illustrate a puncturable closure for the tube of FIG. 1, with FIG. 3 showing the cross-section at line 3-3;

FIG. 4 is a perspective view of the blood collection container including the tube and closure of FIGS. 1-3;

FIG. 5 is a cross-sectional view of an assembly shown with the secondary package in a sealed evacuated condition according to an embodiment of the invention;

FIG. 6 is a perspective view of a primary container before insertion into a secondary package according to an embodiment of the invention;

FIG. 7 is a perspective view of a primary container after removal from a secondary package according to an embodiment of the invention;

FIG. 8 is a perspective view of a primary container after removal from a secondary package according to an embodiment of the invention;

FIG. 9 is a side view of a roll of assemblies as shown in FIG. 8;

FIG. 10 is a perspective view of multiple primary containers before insertion into a secondary package according to an embodiment of the invention;

FIG. 11 is a side view of the embodiment as shown in FIG. 10 with the secondary package in a sealed evacuated condition;

### DETAILED DESCRIPTION

Polypropylene (PP) has long been used in molding and extruding operations for articles such as plastic medical containers and films for the food packaging industry. Polyethylene terephthalate (PET) has more recently been used in molding and extruding operations for these articles. However, PP and PET are somewhat permeable to nitrogen, oxygen, and other gases and vapors. As a result, PP and PET containers are inherently subject to transmission of gases. The invention relates to recognition of, and solutions for, issues associated with such transmission.

Primary containers according to embodiments of the invention include, for example, tubes, bottles, vials, flasks, and single use disposable containers. Particularly useful tubes are those for blood collection. The invention is described below with respect to an evacuated blood collection tube as a primary container, but it will be apparent to one skilled in the art that the description is equally applicable to any other evacuated primary container.

All primary containers, such as evacuated blood collection tubes for example regardless of the intended end use, must meet performance standards to be acceptable for use. The organization NCCLS (National Committee for Clinical Laboratory Standards), now called the Clinical and Laboratories Standards Institute (CLSI) had published a performance standard for manufacturers of evacuated tubes and additives and users of evacuated blood-collection tubes entitled: “Evacuated Tubes and Additives for Blood Specimen Collection Fourth Edition; Approved Standard (NCCLS document H1-A4). These guidelines advocate that a plastic blood collection tube must be evacuated to yield no more than 110% of the claimed draw volume at the point of manufacture and generally maintain a particular draw volume over an anticipated shelf life. In particular the draw volume cannot fall below 81% of the claimed draw volume on expiration of the 12-18 month shelf life. Therefore in some circumstances it may be beneficial to have a barrier to inhibit passage of atmospheric gases through the polymer wall, which would reduce the draw volume.

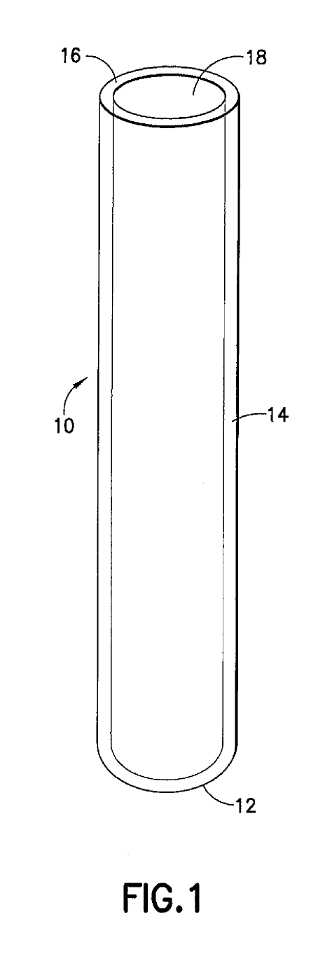

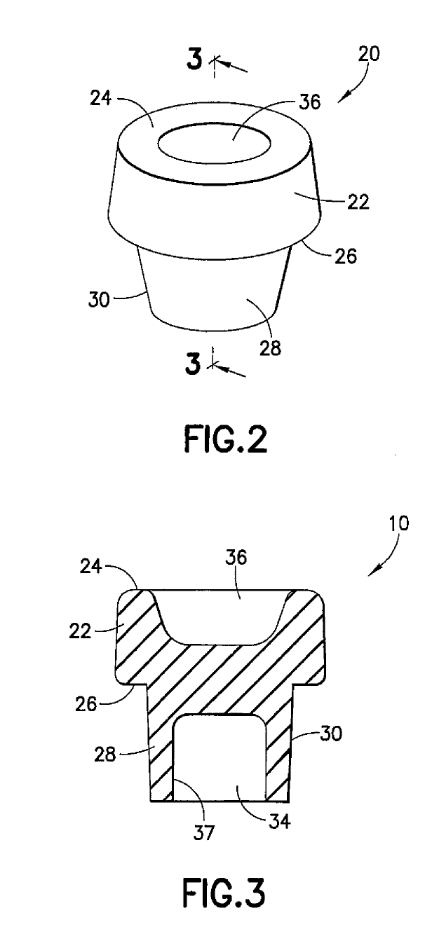

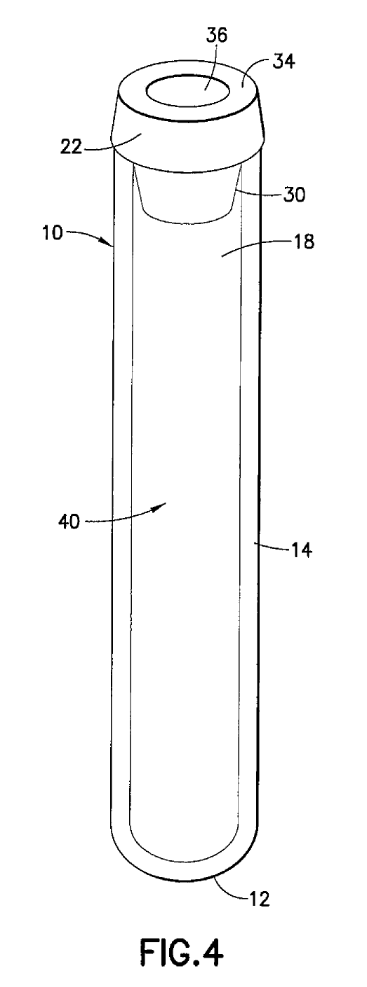

FIGS. 1-4 illustrate an example of a primary container of a blood collection tube and closure. In FIG. 1, tube 10 has bottom wall portion 12 and sidewall portion 14 continuous therewith. Sidewall portion 14 has a top edge 16 and defines an open end 18. A straight sidewall portion is shown for the tube 10, but complex sidewall shapes, for other containers, are also possible. FIGS. 2-3 illustrate a useful closure 20 for open end 18 of FIG. 1. Closure 20 may be one of a variety of forms including, but not limited to, rubber closures, metallic seals, metal-banded rubber seals and seals of different polymers and designs. Closure 20 includes an annular upper portion 22 having a top wall 24. Upper portion 22 has a lower wall or lip 26, which extends over top edge 16 of tube 10 when the closure is in the tube. Closure 20 also includes a lower annular portion or skirt 28 having an outside wall 30 which forms an interference fit with the inside wall surface of tube 10 to maintain the stopper in the tube. Skirt 28 also has an inside wall surface 32, which defines a well 34. Top wall 24 defines a cavity 36. A septum 38 separates well 34 and cavity 36 for penetration by a cannula when the tube assembly is ready for use. FIG. 4 illustrates the tube and stopper assembly ready for drawing a blood sample into enclosed evacuated interior space 40.

The primary containers of the various embodiments of the invention are capable of being formed in any desired size. For example, a tube according to one embodiment is capable of being formed as a conventional evacuated tube 50-150 mm in length and 10-20 mm internal diameter. In particular, standard evacuated tubes, which are 75 or 100 mm in length and have a 13 or 16 mm external diameter, or standard microcollection tubes, which are 40-45 mm long and have a 5-10 mm internal diameter, are possible. Typical wall thicknesses of conventional blood collection tubes, e.g., about 25 to about 50 mil, more typically about 30 to about 40 mil, are possible in tubes according to the invention.

An evacuated blood collection tube can be classified as a full draw tube or a partial draw tube. A full draw tube is one in which the amount of evacuation provides a claimed draw volume of blood greater than half of the total internal volume of the tube. A full draw tube is used to collect blood for typical collection applications such as healthy patients. A partial draw tube is one in which the amount of evacuation provides a claimed draw volume of blood that is half or less of the total internal volume of the tube and is used to collect blood for fragile vein and pediatric applications.

For example an evacuated blood collection tube having a length 75 mm, an external diameter 13 mm, an internal diameter approximately 10 mm and a total internal volume of 7 ml could be classified as a full draw tube if the claimed draw volume was greater than 3.5 ml. Thus the amount of evacuation required to draw greater than 3.5 ml of blood would be in the range of 100 mm to 300 mm Hg. Alternatively, if evacuated blood collection tube was to be classified as a partial draw tube the claimed draw volume would be equal to or less than 3.5 ml and as such the amount of evacuation required to draw equal to or less than 3.5 ml of blood would be in the range of 300 mm to 400 mm Hg. It can be seen that the maximum reduction of 19% in draw volume over the shelf life of a tube (as required by the CLSI guidelines) translates to a decrease of 1 ml in draw volume for a 5.25 ml full draw tube compared to a decrease of 0.3 ml in draw volume for a 1.75 ml partial draw tube. Thus any loss of evacuation by the ingress of air into a tube will be far more detrimental to a partial draw tube.

For use in the specimen collection field, the primary container generally must go through processing steps by which various additives are disposed in the container. For example, additives useful in blood or urine analysis, e.g., procoagulants or anticoagulants, are often disposed into the tube. As known in the art, blood analysis is often performed on serum, and procoagulants are typically used to enhance the rate of clotting. Such procoagulants include silica particles or enzyme clot activators such as elagic acid, fibrinogen and thrombin. If plasma is desired for analysis, an anticoagulant is generally used to inhibit coagulation, such that blood cells can be separated by centrifugation. Such anticoagulants include chelators such as oxalates, citrate, and EDTA, and enzymes such as heparin. Additives are disposed in the primary containers in any suitable manner, liquid or solid, including dissolution in a solvent, or disposing in powdered, crystallized, or lyophilized form.

Additional additives can include a stabilizing agent for stabilizing or inhibiting the degradation of a component within the biological sample such as nucleic acid or proteins in a blood sample. Examples of suitable agents for stabilizing and preserving nucleic acids and/or preventing gene induction include cationic compounds, detergents, chaotropic substances, and mixtures thereof, which are described in U.S. Pat. No. 6,821,789. A protein stabilizing agent may include at least one protease inhibitor. Suitable examples include, but are not limited to, inhibitors of proteases such as serine proteases, cysteine proteases, aspartic proteases, metalloproteases, thiol proteases, exopeptidases and the like, which are described in U.S. patent application Ser. No. 10/436,263.

The primary container may also contain carrier media (e.g., water or alcohol), stabilizing media (e.g., polyvinylpyrollidone, trehalose mannitol, etc.) and/or one or more other additives for treating the biological sample. Suitable additives include, but are not limited to, phenol, phenol/chloroform mixtures, alcohols, aldehydes, ketones, organic acids, salts of organic acids, alkali metal salts of halides, fluorescent dyes, antibodies, binding agents, and any other reagent or combination of reagents normally used to treat biological samples for analysis. Other potential additives include antioxidants and reducing agents, which may help preserve protein confirmation, e.g., preserve sulfhydryl group couplings. It may also be advantageous to include a buffering agent.

It is also possible to include separators in the primary container, e.g., density gradient separators in mechanical or non-mechanical form (e.g., thixotropic gels). Such separators provide for cell separation or plasma separation, for example. See, e.g., European Patent applications EP1006360, EP1006359, EP1005909, EP1014088, EP1106253, and EP0384331, and U.S. Pat. Nos. 4,140,631, 4,770,779, 4,946,601, 6,406,671, 6,280,400, and 6,225,123.

Preparation of a primary container for use in specimen collection, after molding, may include placement of a density gradient separator, disposing an additive, subjecting the container to an evacuated chamber with a pressure below atmospheric pressure, applying a seal such as an elastomeric stopper or pierceable membrane, and sterilizing the container by a process such as irradiation (e.g., with cobalt 60 radiation), ethylene oxide gas exposure, or electron-beam exposure. (Note that several of these steps may be performed in an order other than that presented above).

In one embodiment, subsequent to the preparation of the primary container, the evacuated tube 10 is placed in the secondary container of a polymeric film and metallic foil laminate 102 via an access opening 104 communicating with the interior of the secondary container. The secondary container is then evacuated by removing air from within the secondary container and access opening 104 is sealed, such that the pressure of the internal environment within the sealed secondary container is less than atmospheric pressure typically less than or equal to the pressure of the internal environment with the primary container. Therefore any degradation of the vacuum over time in the primary container will be inhibited as the diffusion of any remaining air from the internal environment of the secondary container to the internal environment of the primary container will be retarded due to the lack of a greater pressure in the external environment surrounding the primary evacuated container. The packaged device will retain the specified volume of vacuum necessary to collect the intended volume of specimen for a longer shelf life in a more reliable manner.

Generally, materials useful as gas barriers have the ability to provide a barrier to mass transfer of elements that are gases at typical atmospheric conditions, such as oxygen, carbon dioxide or nitrogen under a variety of environmental conditions such as temperature and humidity. The resistance to the mass transfer of gas at a certain partial pressure and temperature across a material of certain thickness and contact area can be expressed as the gas transmission rate with the units of [cm3 mil/100 in2•24 hr•atm]. The suitability of a material as a good gas barrier material is determined by the application. Typically, a gas barrier to the transmission of air, which is approximately 79% Nitrogen and 21% oxygen, would have gas transmission rates less than 1.0 [cm³ mil/100 in²•24 hr•atm] (23° C. 0%RH) for nitrogen and less than 15 [cm3 mil/100 in²•24 hr•atm] (23° C. 0%RH) for oxygen.

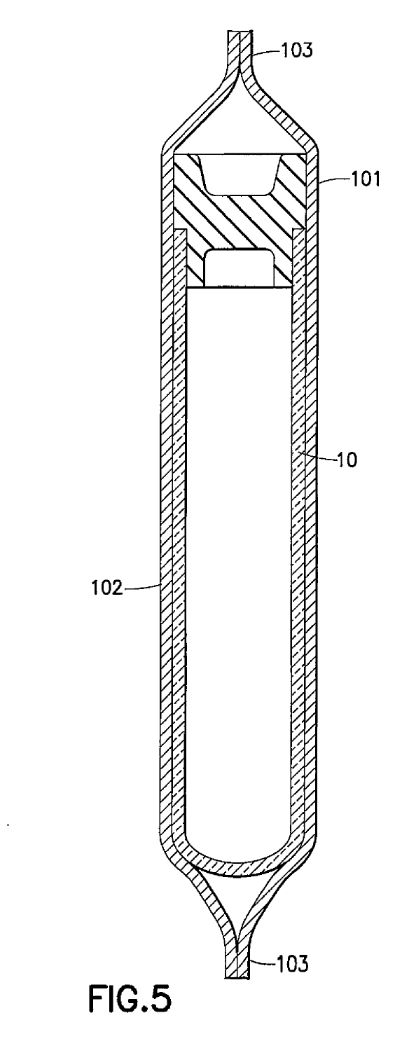

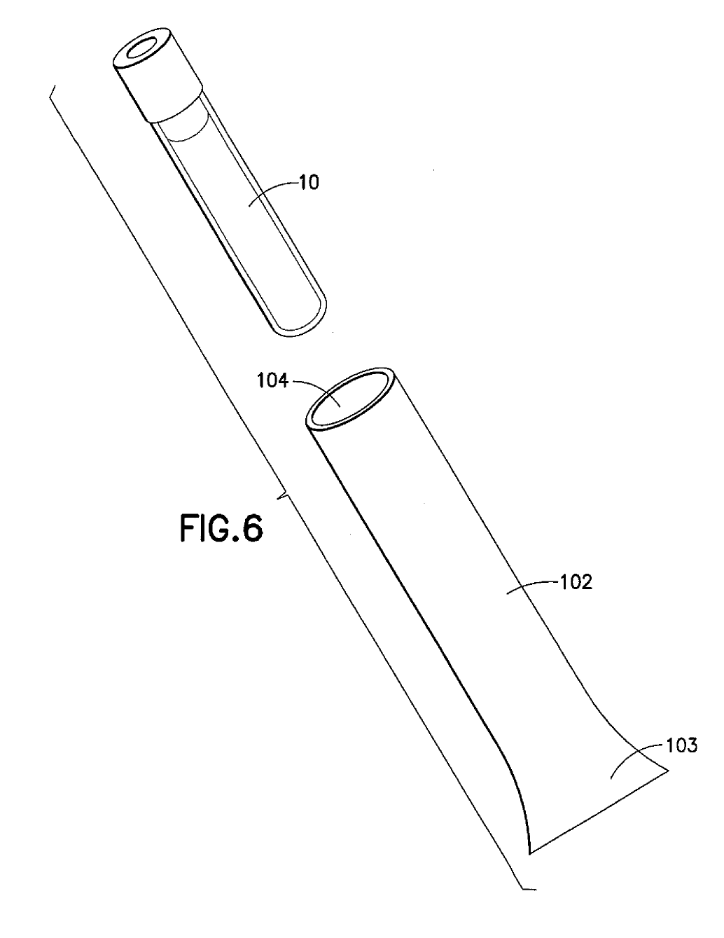

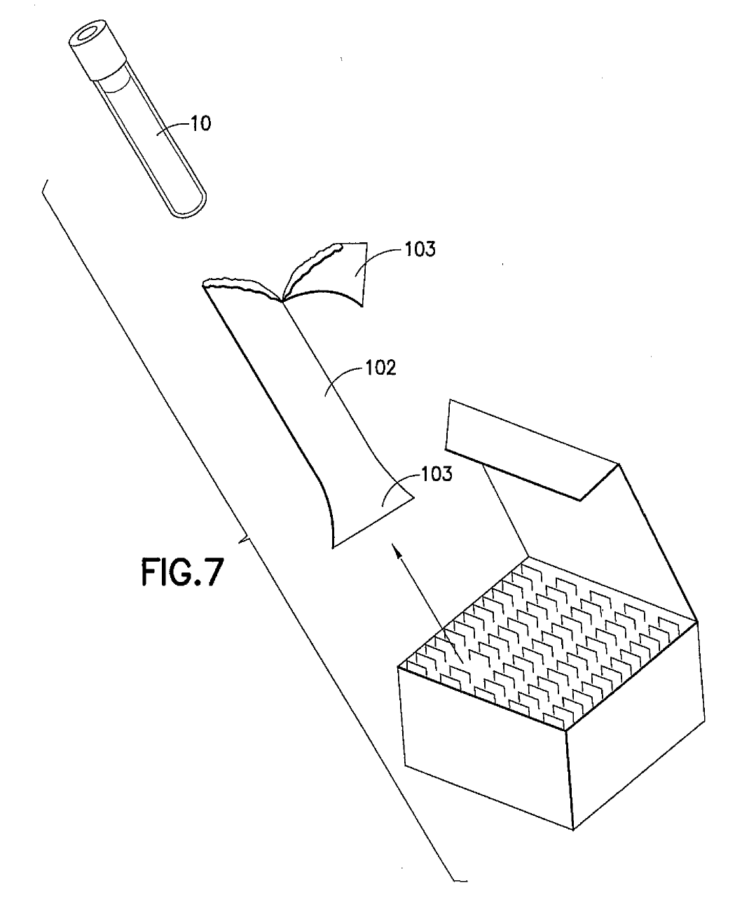

FIGS. 5, 6, and 7 show one embodiment of an assembly 101 in which a primary container is an evacuated tube 10 individually sealed in an evacuated air-tight secondary container or outer package 102 formed from materials useful as gas barriers. Suitable materials for forming such a secondary container include, but are not limited to paper, non-wovens, polymeric film, metallic foil and combinations thereof such as PAKVF4D (a polyethylene terephthalate (PET)/polyethylene (PE)/aluminum foil/linear low density polyethylene (LLDPE) laminate), PAKPM4AO (a polyester/adhesive/low density polyethylene (LDPE) laminate), PAKVF4C (a PET/adhesive/aluminum foil/metallocene polyethylene laminate) made by IMPAK CORPORATION, Los Angeles, Calif. While the entire secondary container or outer package may be made of a flexible material, it is also within the purview of the embodiments of this invention to include secondary container which may be partly rigid and partly flexible.

Assembly 101 includes two seals 103. More than one access opening 104 may be provided, if desired, but this will necessitate a multiplicity of seals thereafter when evacuating the secondary container. It is generally advantageous to keep the number of access opening seals to a minimum in order to reduce the areas of possible leakage. The secondary container may be sealed for example by heat, adhesives, ultra sonic welding, or a mechanical method. The appropriate sealing method will be determined by the type of material form which the secondary package is made.

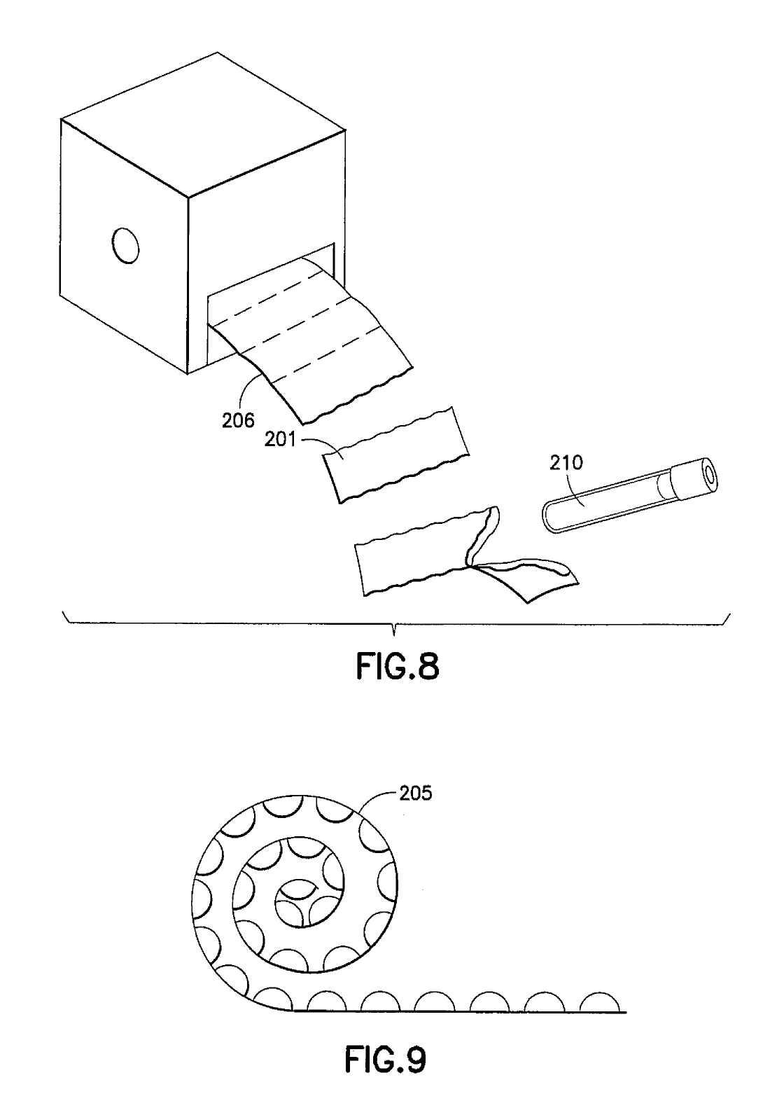

FIGS. 8 and 9 show another embodiment of an assembly 201 in which individual primary evacuated containers 210 are encapsulated within an evacuated secondary container 202. The secondary container is made from a gas barrier material such as a laminated polymeric/metallic foil. Each secondary container 202 is connected to form a roll 205, with serrations 206 formed at the edge of each individual assembly 201 in the dispensing configuration to facilitate separation of each assembly 201 without opening the evacuated secondary package 202.

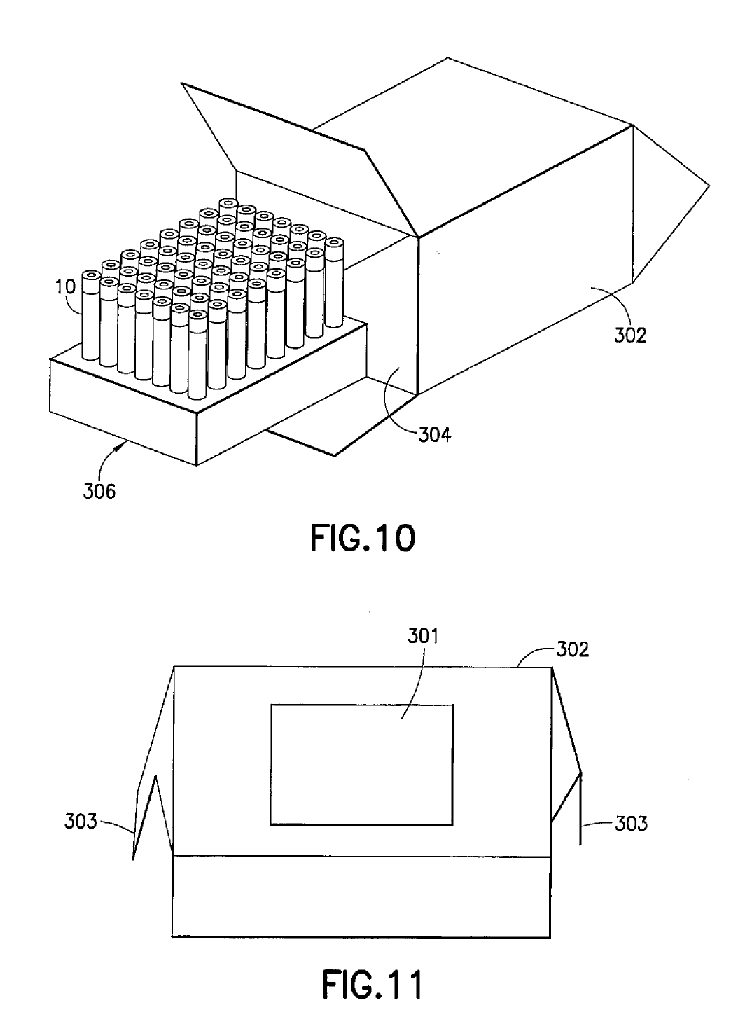

FIGS. 10 and 11 show another embodiment of an assembly 301 in which multiple primary containers that are evacuated blood collection tubes 10 are contained within a single evacuated secondary container 302 in a bulk package configuration. A tray 206 of evacuated tubes 10 is placed in a secondary container 302 such as a laminated polymeric/metallic foil bag. Secondary container 302 is then evacuated to substantially remove all air from within the secondary container and access opening 304 is sealed to form a seal which prevents the ingress of gas into the secondary container 302.

Other embodiments of the invention are also possible, as will apparent to one skilled in the art.

What is claimed is:

1. An assembly comprising:
at least one primary evacuated container,
a secondary evacuated container, which encapsulates said at least one primary evacuated container.

2. The assembly of claim 1, wherein said secondary container inhibits the ingress of gas into said primary evacuated container.

3. The assembly of claim 1, wherein the internal environment of said secondary evacuated container is below atmospheric pressure and equal to or less than the pressure within said primary evacuated container.

4. The assembly of claim 1, wherein said primary evacuated container is a biological sample collection container.

5. The assembly of claim 4, wherein said biological sample collection container is an evacuated blood collection tube.

6. The assembly of claim 5, wherein said evacuated blood collection tube is a full draw tube.

7. The assembly of claim 5, wherein said evacuated blood collection tube is a partial draw tube.

8. The assembly of claim 5, wherein said evacuated blood collection tube comprises:
an evacuated tube having a side wall, a first end, and a second end; and
a closure means for sealing said first end.

9. The assembly of claim 8, wherein said closure means is pierceable by a needle for supplying the sample to said tube.

10. The assembly of claim 9, further comprising a second closure means for sealing said second end.

11. The assembly of claim 8, further comprising a separating member.

12. The assembly of claim 1, wherein said secondary container comprises a gas barrier material.

13. The assembly of claim 12, wherein said gas barrier material has gas transmission rates less than approximately 1.0 [cm³ mil/100 in²•24 hr•atm] (23° C. O%RH) for nitrogen and less than approximately 15 [cm3 mil/100 in²•24 hr•atm] (23° C. 0%RH) for oxygen.

14. The assembly of claim 12, wherein said gas barrier material is selected from the group consisting of paper, non-wovens, polymeric film, metallic foil and combinations of polymeric film and metallic foil.

15. The assembly of claim 1, wherein more than one of said primary evacuated containers are encapsulated within said secondary evacuated container.

16. The assembly of claim 1, wherein more than one of said secondary evacuated containers are connected to form a roll of assemblies.

17. A method of assembly comprising:
providing an at least one evacuated primary container;
providing a secondary container;
inserting said at least one evacuated primary container into said secondary container;
evacuating said secondary container; and
sealing said evacuated secondary container,
wherein said at least one evacuated primary container is encapsulated in said evacuated secondary container.

18. The method of claim 17, wherein the internal environment of said sealed secondary evacuated container is below atmospheric pressure and equal to or less than the pressure within said primary evacuated container.

19. The method of claim 17, wherein said primary evacuated container is a biological sample collection container.

20. The method of claim 19, wherein said biological sample collection container is an evacuated blood collection tube.

21. The method of claim 20, wherein said evacuated blood collection tube is a full draw tube.

22. The method of claim 20, wherein said evacuated blood collection tube is a partial draw tube.

23. The method of claim 17, wherein said secondary container comprises a gas barrier material.

24. An assembly comprising at least one evacuated container, sealed within an evacuated outer package.

25. The assembly of claim 24, wherein said evacuated outer package further comprises a gas barrier material.

26. The assembly of claim 25, wherein said gas barrier material has gas transmission rates less than approximately 1.0 [cm³ mil/100 in²•24 hr•atm] (23° C. 0%RH) for nitrogen and less than approximately 15 [cm³ mil/100 in²•24 hr•atm] (23° C. 0%RH) for oxygen.

27. The assembly of claim 24, wherein said evacuated outer package inhibits the ingress of a gas into said evacuated container.
